(19) United States
(12) Patent Application Publication
(10) Pub. No.: US 2023/0117451 A1
(43) Pub. Date: Apr. 20, 2023

(54) Hydroponics farming apparatus, and systems including the same

(71) Applicant: Farm Locally Limited, Hong Kong (CN)

(72) Inventor: Edwin Yat-Wang CHAN, Hong Kong (CN)

(21) Appl. No.: 17/452,260

(22) Filed: Oct. 26, 2021

(30) Foreign Application Priority Data
Oct. 20, 2021 (HK) 32021040786.4

(51) Int. Cl. A01G 31/02; G05B 19/042; C02F 1/44

(52) U.S. Cl. CPC A01G 31/02; G05B 19/042; C02F 1/441; G05B 2219/2625; G05B 2219/2605; C02F 2209/02; C02F 2103/08

(57) ABSTRACT

Embodiments of the present invention provide hydroponics farming apparatus, and systems including the same. The farming apparatus comprises a frame, a plurality of functional systems, a first plurality of sensors configured to monitor conditions associated with farming of the one or more plants, and one or more modular storage cabinets removably attached to the frame. The one or more modular storages include electronics that are pre-assembled and configured to communicate with one or more of the first plurality of sensors and the plurality of functional systems. The electronics includes a main controller configured to collect data from the first plurality of sensors.

### CROSS-REFERENCE TO RELATED APPLICATIONS

This application claims priority to Hong Kong Short-term patent application Ser. No. 32021040786.4, filed Oct. 20, 2021, entitled “Hydroponics farming apparatus, and systems including the same,” hereby incorporated herein by reference as to its entirety.

### FIELD OF THE INVENTION

The present invention relates to hydroponics farming.

### BACKGROUND

There are growing needs for fresh food in the world. Food shortage may be caused by various reasons, such as population increase, climate change, insufficient investment, lack of talents in the industry, etc. Many regions depend heavily on external food supply. Take Hong Kong as an example. According to statistics, 95% of food supply are provided from other countries or regions. Hydroponics farming has been developed to increase food supply, but the existing systems are still unsatisfactory.

New farming apparatus, system, and methods that assist in advancing technological needs and industrial applications in hydroponics farming are desirable.

### SUMMARY

According to one aspect of the embodiments, it is provided with a hydroponics farming apparatus for plant production. The farming apparatus comprises a frame configured to define an interior space for farming one or more plants, a plurality of functional systems configured to facilitate farming of the one or more plants, a first plurality of sensors configured to monitor conditions associated with farming of the one or more plants, and one or more modular storage cabinets removably attached to the frame. The one or more modular storage cabinets include electronics that are pre-assembled and configured to communicate with one or more of the first plurality of sensors and the plurality of functional systems. The one or more modular storage cabinets further include interfaces that are pre-constructed and configured to interface with one or more of the plurality of functional systems. The electronics includes a main controller configured to collect data from the first plurality of sensors and provide instructions related to controlling of the plurality of functional systems.

According to another aspect of the embodiments, it is provided with a hydroponics farming system for plant production. The hydroponics farming system comprises at least one hydroponics farming apparatus for farming one or more plants, each of the at least one hydroponics farming apparatus including one or more modular storage cabinets removably mounted within the hydroponics farming apparatus, one or more networks, and a cloud server communicating with the at least one hydroponics farming apparatus via the one or more networks. The cloud server includes a storage for storing data received from the at least one hydroponics farming apparatus and an artificial intelligence processor for processing the data based on an artificial intelligence algorithm to obtain processed results. The cloud server is configured to generate instructions based on the processed results and provide the instructions to the at least one hydroponics farming apparatus for controlling farming of the one or more plants.

Other example embodiments are discussed herein.

### BRIEF DESCRIPTION OF THE DRAWINGS

FIG. 1 illustrates a hydroponics farming apparatus according to an example embodiment of the present invention.

FIG. 2 illustrates a modular storage cabinet according to an example embodiment of the present invention.

FIG. 3A illustrates a hydroponics farming apparatus according to an example embodiment of the present invention.

FIG. 3B illustrates an internal arrangement of the hydroponics farming apparatus as illustrated in FIG. 3A.

FIG. 4 is an illustration illustrating operation inside a hydroponics farming apparatus according to an example embodiment of the present invention.

FIG. 5A illustrates plants to be used in a bucket system according to an example embodiment of the present invention.

FIG. 5B illustrates plants to be used in a tower system according to an example embodiment of the present invention.

FIG. 5C illustrates plants to be used in a stack tray system according to an example embodiment of the present invention.

FIG. 6 illustrates a hydroponics farming system according to an example embodiment of the present invention.

FIG. 7 illustrates a hydroponics farming system according to another example embodiment of the present invention.

FIG. 8 is a flowchart illustrating a hydroponics farming method according to an example embodiment of the present invention.

FIG. 9 is a flowchart illustrating a hydroponics farming method according to another example embodiment of the present invention.

### DETAILED DESCRIPTION

Example embodiments relate to hydroponics farming apparatus, systems, methods that facilitate plant production.

Many existing hydroponics systems and designs are pre-constructed inside a shipping container. For example, the shipping container may be typically sized to be 12 meters in length by 2.44 meters in width by 2.89 meters in height. The available space inside the shipping container becomes limited and relatively small for growing plants after the container is equipped with all the required equipment and hardware. Further, as the shipping container is pre-constructed, it is difficult to offer a system with the ability for customization. It is difficult to modify the system by incorporating new features. Cost of logistics is also high for transporting the shipping container to a remote location and logistics could be a hurdle for some users with limited resources. Further, the existing system design generally allows users to grow only a single product (mainly lettuce due to the less required amount of space needed) and a full redesign is required in order to grow a different product.

Further disadvantages as recognized by the present inventor include necessity of extensive human input and agricultural knowledge. The existing system design typically uses an onboard software management system that has limited functions. As a result, it may allow users to control only one individual container. Further, there may be substantial inconsistence and incompatibility for equipment, hardware and software provided by different providers. This also requires great extent of human intervention.

Example embodiments solve one or more these problems associated with the existing system design and provide technical solutions with new design regarding hydroponics farming apparatus, systems, and methods.

Example embodiments include a hydroponics farming apparatus that is provided with a democratic and modular design concept to simplify logistics and installation for users. According to one or more embodiments, frame structure of a hydroponics farming apparatus can be manufactured in a customized size different from (such as larger than) a standard size of the existing shipping container. The frame structure adopts a modular design that requires simple assembly after it has arrived at a destination. Users can conveniently relocate the hydroponics farming apparatus from one place to another at a lowered logistic cost. That is, the hydroponics farming apparatus is a portable arrangement.

According to one or more embodiments, the hydroponics farming apparatus provides improved flexibility and compatibility. In contrast with a fully-assembled system of the existing design, the design concept as provided herein uses democratic design process which provides users ready-to-assemble hydroponics systems that users can build on their own. The modular design offers users one or more pre-constructed storage cabinets fitted with various technical equipment. Users simply need install or mount the storage cabinet(s) at one or more dedicated locations (depending on the number of the storage cabinets) inside the farming apparatus and connect elements required together (such as electrical or mechanical connections) for the hydroponics system to operate.

As the storage cabinet is formed as a pre-constructed module where various electronics and interfaces are pre-assembled, users could easily assemble the hydroponics farming apparatus or hydroponics farm with less expertise. For example, users do not need extensive knowledge to assemble electronics. This reduces labor as well as chances of errors. On the other hand, it is easier to disassemble it due to lack of necessity to disassemble all the electronics and components as pre-assembled in the cabinet. This can reduces significant labor.

Furthermore, the system design according to one or more embodiments provides improved flexibility and compatibility. The storage cabinet can be customized according to practice needs. For example, electronics in the storage cabinet can be easily programed or modified to adapt to various needs. Hardware or elements can be conveniently incorporated to add new or extra applications without substantially modifying the rest parts of the system.

The hydroponics farming design as described herein may allow users to grow a wide variety of plants or crops. The size of the frame structure could be increased to establish a larger farming area and allow increased amount of plants to be produced, thereby improving crop production. It also reduces the need for expertise in agriculture and allows users with little or no experience to begin farming in a desirable location.

Example embodiments include a hydroponics farming system including one or more hydroponics farms. Each hydroponics farm can be located in a desirable location and remotely controlled by an artificial intelligence (AI) system that may be fully automated by utilizing big data and cloud computing technology to manage the technical part of the farming process. Each hydroponics farm is equipped with multiple sensors for collecting data to be used by the AI system to give instructions to control all the equipment needed in providing elements (such as light, air, water, nutrition, etc.) required for plants to grow.

According to one or more embodiments, a hydroponics farming system provides and collects formulated data that may be used to increase consistent quality control, thereby enabling controlling over multiple hydroponics farms located in different locations with lesser investment in manpower and equipment. Further, as a result, every farm has the ability to collect and provide uniformed data, therefore providing users with accurate agricultural data that could be used in other farms regardless of locations to diminish discrepancy from human input.

The formulated data collection methods can be executed by providing same equipment and hardware to all users to obtain consistent data. These methods facilitate deep leaning required by the AI system by providing consistent data regardless where the farms are located as well as the type of plants being grown. Users no longer need to have prior experience or knowledge to begin farming with simplified technical aspects. The data collection methods allow the AI system to improve and control the farming requirements that plants need. The data collected may be stored in a cloud server and used for data training and development of learning modes. With the data collected and farming management, the system facilitates innovation for agricultural industry and benefits food supply sustainability.

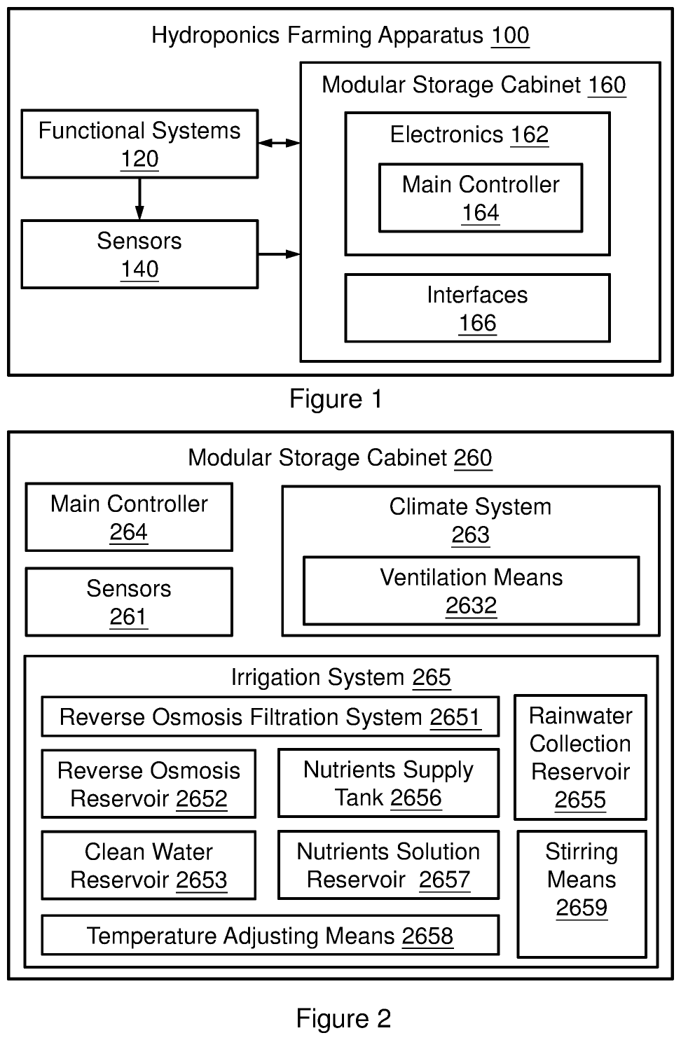

FIG. 1 illustrates a hydroponics farming apparatus 100 according to an example embodiment of the present invention. The hydroponics farming apparatus 100 establishes a farm or farming area for producing one or more plants or crops.

The hydroponics farming apparatus 100 has a frame configured to define an interior space for farming plants. As illustrated, the hydroponics farming apparatus 100 includes a plurality of functional systems 120, a first plurality of sensors 140, and one or more modular storage cabinets 160.

The functional systems 120 facilitate farming of the one or more plants by performing one or more functions. By way of example, the functional systems 120 may include a plurality of lighting devices that provide light required for growing the plants, such as for carrying out photosynthesis. The lighting devices may include one or more incandescent light sources (such as incandescent bulbs), luminescence light sources (such as light-emitting diodes (LED), or the like.

The lighting devices may be arranged in proper locations. For example, in an embodiment, at least a first one or more of the lighting devices are attached to an interior wall of the hydroponics farming apparatus 100, while at least a second one or more of the lighting devices are attached to a ceiling of the hydroponics farming apparatus 100. Alternative arrangement is possible. The interior wall or ceiling may be part the frame.

By way of example, the functional systems 120 may include one or more energy harvesting devices for harvesting energy from the nature. In some embodiments, the energy harvesting devices may include one or more photovoltaic devices. The photovoltaic devices may be solar panels that are disposed onto the roof or constitute part of the roof of the hydroponics farming apparatus 100. The roof may be defined by the frame, such as being part of the frame. The solar panels may be formed from inorganic materials, such as silicon, or organic materials, such as polymers. The photovoltaic devices utilizes solar energy to charge energy storage devices (such as batteries) or power electronics of the hydroponics farming apparatus 100.

In some other embodiments, the energy harvesting devices may include wind turbines that harvest wind energy. The wind turbines may be disposed in proper locations. By way of example, there may be four wind turbines each arranged at a corner of the farm and attached to the frame of the hydroponics farming apparatus 100.

In some other embodiments, the energy harvesting devices include hydrogen fuel cells for energy storage. By way of example, solar or wind energy can be used to electrolyse water and split oxygen and hydrogen. The oxygen is released and the hydrogen is stored in the hydrogen fuel cells. The hydrogen gas is then converted back into electricity when necessary from the hydrogen fuel cells. As a result, this can replace the use of batteries as an energy storage. Other types of energy harvesting devices are also possible as long as they are capable of harvesting a certain type of energy from the nature.

By way of example, the functional systems 120 may include one or more video-capturing devices, such as video cameras. Visual information (such as videos, images) of the growth environment of plants or of the plants per se can be captured by the video cameras and subsequently processed and based to facilitate controlling of the farming process.

Optionally or additionally, the functional systems 120 includes a pollination device that helps collect pollen from a male plant and mechanically facilitate transferring pollen to fertilize female plants. This is favorable for farming of certain plants, in certain geographic areas, or in certain seasons. In some embodiments, for example, the pollination device can generate soap bubbles that are able to deliver pollen to flowers for fertilizing plants. The pollination device can be properly installed in the farm and controlled by an onsite controller or by a cloud server remotely.

The functional systems 120 may include others elements, such as pipelines that convey fluid, connections that interface with the modular storage cabinets 160, the sensors 140, or the plant unit (such as a plant pot), etc. The functional systems 120 may include mechanical elements or electrical elements.

The sensors 140 may include various sensors that monitor conditions associated with farming of the plants. The sensors 140, for example, may include one or more temperature sensors, humidity sensors, light sensors, gas sensors etc. For example, light sensors may be provided to collect lighting information associated with the lighting devices. The lighting information may include but not limited to light intensity, distribution, luminous time, etc., and can be based to monitor or adjust the lighting devices, thereby achieving lighting conditions desirable for farming the plants.

The modular storage cabinets 160 may be removably attached to the frame of hydroponics farming apparatus 100. The number of the modular storage cabinets 160 may be one, two, or more. The modular storage cabinets 160 include electronics 162 that are pre-assembled and configured to communicate with one or more of the sensors 140 and the functional systems 120. The modular storage cabinets 162 include interfaces 166 (such as electrical interfaces or mechanical interfaces) that are pre-constructed and are able to interface with one or more of the sensors 140 and the functional systems 120. The electronics 162 includes a main controller 164 that communicates with the sensors 140 for data collection. The main controller 164 can process the collected data and provide instructions related to controlling of the functional systems 120.

In an embodiment, the main controller 164 communicates with an external electronic system, such as a server, a personal computer, a smart phone, a laptop, etc. via one or more networks, such as wired or wireless networks. The main controller 164 may send the collected data to the external electronic system for processing, and provide instructions related to controlling of farming based on the processed results by the external electronic system. Alternatively or optionally, the main controller 164 may process the data on its own and then communicate to the external electronic system such as the processed results can be displayed visually on the external electronic system for users' review. Alternatively or optionally, users may provide instructions via the external electronic system to the main controller 164 to control farming of plants in the hydroponics farming apparatus 100. The collected data may be stored in the electronics 162 for a period of time.

FIG. 2 illustrates a modular storage cabinet 260 according to an example embodiment of the present invention. The modular storage cabinet 260, for example, may be a specific implementation of the modular storage cabinet 160 with reference to FIG. 1.

As illustrated, the modular storage cabinet 260 includes sensors 261, a climate system 263, a main controller 264, and an irrigation system 265. The main controller 264, for example, may be a specific implementation of the main controller 164 with reference to FIG. 1. The main controller 264 electrically communicates with sensors 261 and sensors disposed in the hydroponics farming apparatus but outside of the modular storage cabinet 260. The main controller 264 may further exchange data with one or more remote electronic devices (such as servers, laptops, smart phones, iPad, etc.).

The sensors 261 detects further conditions associated with farming of plants. For example, the sensors 261 may be used to monitor the internal environment of the modular storage cabinet 260. The sensors 261 may collect data related to operation status of the climate system 263 or the irrigation system 265, or both, and then provide the collected data to the main controller 264.

The climate system 263 controls environmental conditions of a hydroponics farming apparatus when the modular storage cabinet 260 is disposed in the hydroponics farming apparatus. As illustrated, the climate system 263 includes ventilation means 2632. The ventilation means 2632 may include one or more fans or blowers. The fans may interface with one or more air duct pipes mounted to the frame of the hydroponics farming apparatus for managing temperature and humidity inside the farm. The sensors 261 may include an air temperature sensor, a humidity sensor, etc. for monitoring parameters such as temperature and humidity of the climate system 263.

As illustrated, the irrigation system 265 includes a reverse osmosis filtration system 2651, a reverse osmosis reservoir 2652, and a clean water reservoir 2653. The reverse osmosis filtration system 2651 filters water received from a water supply, such as an external water tank or a rain source. The reverse osmosis reservoir 2652 stores water received from the reverse osmosis filtration system 2651. The clean water reservoir 2653 stores water received from the reverse osmosis reservoir 2652.

In some embodiments, the sensors 261 further includes a volume sensor and a temperature sensor. The temperature sensor is disposed in the clean water reservoir 2653 and monitors water temperature. The volume sensor monitors volume of water in the clean water reservoir 2653.

As illustrated, the irrigation system 265 includes a nutrients supply tank 2656 for supplying nutrients and a nutrients solution reservoir 2657 connected to the nutrients supply tank 2656 and for preparing nutrients solution. The sensors 261 may include sensing means disposed in the irrigation system 265 that monitor parameters associated with nutrients solution. A temperature adjusting means 2658 (such as cooling condenser, heater, etc.) is provided to adjust temperature of the nutrients solution. A stirring means 2659 including a stirring motor is provided to mix or stir the nutrients solution. The nutrients solution reservoir 2657 may interface with a nutrients solution conveying means (such as one or more nutrients solution supply pipes mounted to the frame of the hydroponics farming apparatus) such that nutrients solution can be conveyed to the plants under farming. Additionally, the nutrients solution reservoir 2657 may interface with a nutrients solution returning means (such as one or more nutrients solution return pipes mounted to the frame or a bottom floor onto which fluid can flow) such that the unused nutrients solution can return to the nutrients solution reservoir 2657 for further use.

In some embodiments, the irrigation system 265 includes one or more power of hydrogen (pH) adjustment tanks. By way of example, the irrigation system 265 includes a pH up tank and a pH down tank in fluid communication with the nutrients solution reservoir 2657. By way of example, the pH up tank may include potassium hydroxide (KOH) and potassium carbonate (K₂CO₃). The pH down tank may include phosphoric acid (H₃PO₄), such as food-grade H₃PO₄. When the pH level of the nutrients solution is low, contents in the pH up tank can be transferred into the nutrients solution reservoir 2657 to increase the pH level. When the pH level of the nutrients solution is high, contents in the pH down tank can be transferred into the nutrients solution reservoir 2657 to decreases the pH level. In this way, the pH level of the nutrients solution can be kept in a desirable level.

As illustrated and optionally, the irrigation system 265 further includes a rainwater collection reservoir 2655 for rainwater collection. The rainwater collection reservoir 2655 may interface with rain collection means (such as rain collection pipes mounted to the frame of the hydroponics farming apparatus) such that rains falling onto the hydroponics farming apparatus can be collected for use. This can save significant amount of water supply particularly in rainy areas.

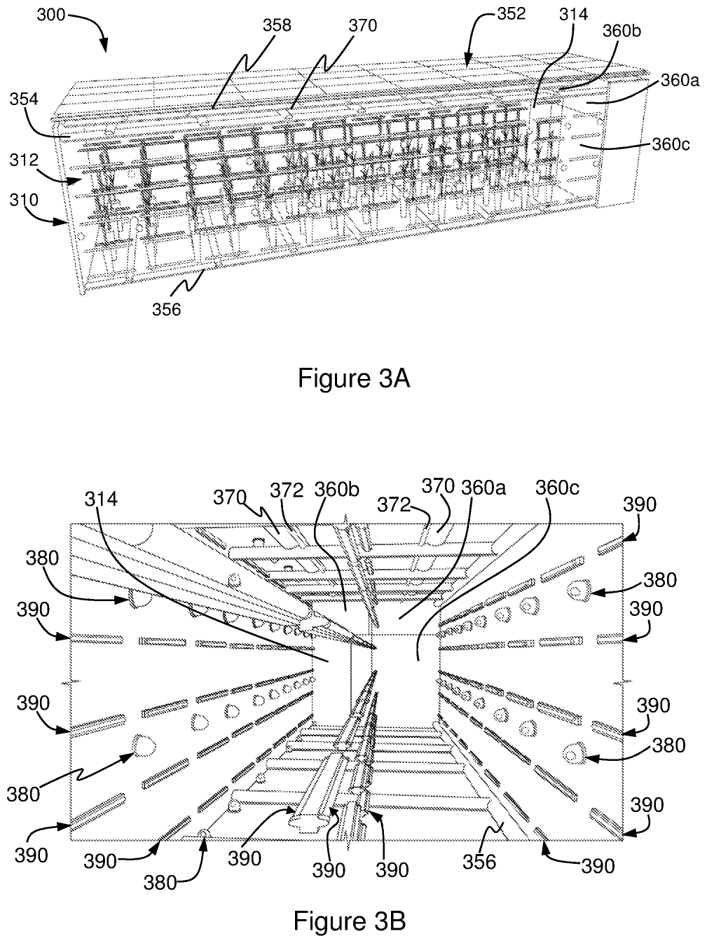

FIGS. 3A-3B illustrates a hydroponics farming apparatus 300 according to an example embodiment of the present invention. For example, the hydroponics farming apparatus 300 may be a specific implementation of the hydroponics farming apparatus 100 with reference to FIG. 1.

The hydroponics farming apparatus 300 is portable and can be relocated from a first physical location to a second physical location with reduced logistic cost.

As illustrated, the hydroponics farming apparatus 300 includes a frame structure or frame 310 equipped with heat insulated walls and ceiling. The frame 310 in assembly is illustrated as having cuboid configuration despite other configurations are also possible. The frame 310 may be formed of proper materials, such as metal. The frame can be sized according to practice needs. The frame 310 defines an internal space 312 for plant farming. By way of example, the frame has a dimension of 12 meters (L) by 3 meters (W) by 3 meters (H). The interior floor may be layered with polyvinyl chloride (PVC) tiles that is water resistant.

The entrance 314 of the hydroponics farming apparatus 300 is located at a proper location for people coming in or out and is equipped with an air shower that is fitted with a security control system. FIGS. 3A and 3B illustrate three modular storage cabinets 360a, 360b, and 360c disposed proximate to the entrance 314. The storage cabinets 360a, 360b, and 360c contain technical equipment, such as electronics, interfaces, etc. The three storage cabinets are for illustrative purpose only. In some embodiments, there may be less cabinets (such as one or two) or more cabinets (such as four, five, or more).

In the present embodiment, electronics, such as the onsite main controller or controller circuit, data storage or memory, and network interfaces, are stored inside the storage cabinet 360a. The collected data from various sensors inside the hydroponics farming apparatus may be stored temporarily in the data storage. The main controller may process the collected data and send the processed results to an offsite main server controller and big data storage using cloud computing technology. The data may then be used by an AI system to provide instructions that are sent back to the onsite controller to control operation of the hydroponics farming apparatus.

A climate system is provided in the storage cabinet 360b. The climate system includes a heating, ventilation, and air conditioning (HVAC) system. A plurality of air temperature sensors and humidity sensors are provided. For example, some sensors are arranged within the internal space 312, while some sensors are arranged exterior to the frame 310. These sensors collect environmental data such as temperature, humidity, etc., and provide the collected data to the main controller. The main controller, based on these data, controls operation of the HVAC system. For example, the HVAC system may include circulation fans, intake fans or exhaust fans. The controller may instruct to turn on or turn off one or more of these fans as so to manage temperature and humidity inside the farm. Further, as illustrated in FIG. 3B, two air duct pipes 370 are mounted to the ceiling and are connect to the storage cabinet 360b. The two air duct pipes 370 are illustrated as being mounted to opposite sides. Each air pipe is divided between two columns of plants for equal distribution that runs horizontal lengthwise from front to back. In some embodiments, the HVAC system is disposed in the farm but outside of the storage cabinets. In some other embodiments, at least part of the HVAC system is disposed one or more of the storage cabinets.

An irrigation system is provided in the storage cabinet 360c. The irrigation system includes a reverse osmosis filtration system, a reverse osmosis reservoir and a clean water reservoir, such as the reverse osmosis filtration system 2651, the reverse osmosis reservoir 2652 and the clean water reservoir 2653 with reference to FIG. 2. Fresh water supply is connected to the farm controlled by a solenoid valve and a pump. The fresh water is then filtered through the reverse osmosis filtration system and stored in the reverse osmosis reservoir and is then transferred to the clean water reservoir with the pump once the solenoid value is opened. A temperature sensor is fitted inside the clean water reservoir to record the temperature. The clean water reservoir include a volume sensor that monitors quantity of clean water so as to ensure there is sufficient clean water for operating the farm. When the solenoid valve is open, the clean water is transferred with the pump to a nutrients solution reservoir (such as the nutrients solution reservoir 2657 with reference to FIG. 2) to ensure a proper level of mixture of clean water and nutrients before being used in the hydroponics system. By way of example, optionally and additionally, the irrigation system can include a rain water collection reservoir, such as the rain water collection reservoir 2655 with reference to FIG. 2. Rain collection pipes 358 are installed on one side of the roof such that rain can be collected.

Optionally and additionally, the irrigation system can include a seawater desalination reverse osmosis system that is able to transform unusable seawater into water that is proper for irrigating plants in a farm by using technology of reverse osmosis. This is favorable for farming in a geographic location where fresh water is limited but abundant seawater is accessible. By way of example, seawater is taken from a sea by pumping means. After screening out of debris, sand and grit by screening means, the seawater passes through a series of treatments including coagulation, flocculation and filtration to remove fine and suspended solids. Seawater is then pushed against a semi-permeable membrane that only allows water molecule to pass through at high pressure, while most of the salts present in the seawater is blocked, forming concentrated salt water which is returned to the sea. The seawater undergoes multiple stages of reverse osmosis to enhance salts removal. The purified water can be used as process water for plant production in the farm.

The seawater desalination reverse osmosis system can be installed in one of the modular storage cabinets with communication channels (such as pipes) in fluid communication with a seawater source and plant receiving apparatus (such as pots, trays, etc.). Alternatively, the seawater desalination reverse osmosis system can be provided as a standalone system that can be installed as part of a hydroponics farming apparatus but outside modular storage cabinets. This provides flexibility. For example, the seawater desalination reverse osmosis system can be provided for farming only in certain areas where fresh water is limited or scarce.

The irrigation system further includes a nutrients solutions reservoir and a nutrients supply tanks, such as the nutrients solutions reservoir 2657 and the nutrients supply tanks 2656 with reference to FIG. 2. A nutrients solution volume sensor is provided to measure amount of nutrients solution that is currently in the nutrients solution reservoir. When the nutrients solution is below a pre-determined volume or the quality does not meet a pre-determined requirement, the filtered water from the clean water reservoir will be transferred to the nutrients solution reservoir controlled by a solenoid valve and a pump. A temperature sensor is provided to ensure a desirable temperature is maintained. A cooling condenser or heating coil is provided to cool or heat the nutrients solutions to a desirable temperature before being used in the hydroponics system. A dissolved oxygen (DO) sensor is provided to measure oxygen level in the nutrients solution. An oxygen pump may turn on to increase the oxygen level in the nutrients solution or turn off once the oxygen level has been reached. An electrical conductivity (EC) sensor and a pH sensor may be provided to measure nutrients level in the nutrients solution. In some embodiments, once obtaining the EC and pH levels, an AI system will determine the desirable amount of nutrients required to be added into the nutrients solution from three nutrients supply tanks controlled by one or more solenoid valves. Each nutrients supply tank is equipped with a volume sensor to ensure sufficient nutrients are available or the need to refill nutrients once the nutrients are below a certain volume. The desirable or correct amount of fresh water and nutrients can be added into the nutrients solution with the stirring motor turned on to mix the solutions thoroughly. Once reaching desirable level of EC and pH, the nutrients solution can be provided into the hydroponics system. Further, a pH up tank and a pH down tank are provided in fluid communication with the nutrients solutions reservoir such that the pH level of the nutrients solutions therein can be adjusted when necessary. The remaining nutrients solution that has been used in the hydroponics system can be collected and reused until the EC and pH level cannot be reached to an optimal or predetermined level. The waste nutrients solutions may be transferred with a pump to an external waste water reservoir for collection. A nutrients solution supply pipe 354 is mounted to the ceiling with one main pipe mounted on one side (such as the left side) that runs horizontal lengthwise connected to the storage cabinet 360c. The main pipe is divided into seven sub pipes that runs from the one side to the other side (such as the right side) where it is distributed between the fourteen rolls of plants for equal distribution.

A nutrients solution return pipe 356 is mounted under the floor (for visibility, the floor is removed) with one main pipe mounted on the left side that runs horizontal lengthwise connected to the storage cabinet 360c. The seven sub pipes that runs from right-side to left-side where it is connected to the main pipe that runs horizontal lengthwise connected to the storage 360c where it houses the nutrients solution reservoir. When the nutrients solution is no longer optimal or below the predetermined value, the nutrients solution reservoir may transfer the waste nutrients solution to an external waste water reservoir.

In some other embodiments, the nutrients solution return pipe 356 is not used. Rather, other proper ways to collect waste nutrients solution can be adopted. For example, the floor can be used to collect waste nutrients solution. The floor can be formed with a slope such that the waste flows under gravity towards a predefined tank or area for collection. Bridges can be provided above the floor so that users can walk on. Alternatively, there may be an extra floor (called top floor) arranged on top of the floor (called bottom floor) that flows waste. The extra floor can be formed in such a way that allows fluid to pass downward and drop onto the bottom floor.

Multiple lighting devices are arranged in the farm. As illustrated, LED lights 390 provide light inside the farm with the same spectrum as the sun covering the interior surface area. There are four columns of LED lights 390 mounted horizontal from the ground to ceiling lengthwise from front to back. Additionally two columns are mounted back-to-back hanging from the ceiling. Light sensors are arranged in proper locations and provide light-related data to the onsite controller to manage the lighting schedule that controls the LED lights when to turn on or turn off.

Energy harvesting devices are provided to harvest energy. In the present embodiment as illustrated, solar panels 352 are installed on the roof that partially or fully covering the surface area of the roof. The solar panels 352 are connected to the storage cabinet 360a that contains a balance of system (BOS). The BOS may include combiner boxes, charge controllers and storage batteries or battery packs for standalone systems, inverters, mounting structures, wiring, switchgear and fuses, surge arrestors, earth-fault protection devices etc. The charge controller manages electricity collected from the solar panels 352 and converts the electricity from alternating current (AC) to direct current (DC). A grid electricity input sensor is provided to collect data of the amount of electricity that is provided to the grid electricity when the battery packs are already at maximum capacity. A grid electricity output sensor is provided to collect data of the amount of electricity used for the farm when the battery packs are empty. A battery pack input sensor is provided to collect data of the amount of electricity collected from the solar panels. A battery pack output sensor is provided to collect data of the amount of electricity used for the farm. A battery pack volume sensor is provided to monitor the amount of electricity stored within the battery pack. An optional generator output sensor is provided to collect data of the amount of electricity used from the generator. The sensors and the BOS communicate with the onsite controller that controls power supply of the farm. In some other embodiments, the energy harvesting devices may be wind turbines for harvesting wind energy. Other types of energy harvesting devices may be possible.

Video-capturing devices are provided to capture visual information. As illustrated, cameras 380 (such as high definition cameras, 4K cameras, or other kinds of cameras, such as cameras with other resolutions) are mounted horizontal from the ground to ceiling lengthwise from front to back. One column is mounted on the right-side wall and one column on the left-side wall. The cameras 380 cover the interior surface area that collects data by the onsite controller that send the collected data to an AI system to analyse the status and health of plants under farming. The cameras 380 may additionally provide security for the farm. The cameras 380 may additionally provide video streaming for users such that users can visually see the environment inside the farm.

A carbon dioxide (CO₂) level sensor is provided to measure the CO₂ content inside the farm. The data collected allows the main controller or an AI system to control the CO₂ tank solenoid value to open or close until the correct CO₂ level has been reached. A CO₂ supply tank sensor is provided to ensure there is CO₂ available to refill when it is below a certain level. CO₂ supply means 372 is mounted to the ceiling with two pipes one on the left-side and one on the right-side where each pipe is divided between two columns of plants for equal distribution that runs horizontal lengthwise connected to the storage cabinet 360c where it houses a CO₂ supply tank. By way of example, typically the CO₂ level within air is 400 ppm. On average CO₂ in the farm can be kept within 1200-1500 ppm. The CO₂ supply tank sensor is located at the tank with a pressure gauge. The main controller or the AI system can take the reading from the CO₂ supply tank sensor and controls the solenoid valve to release the current amount of CO₂ from the supply tank.

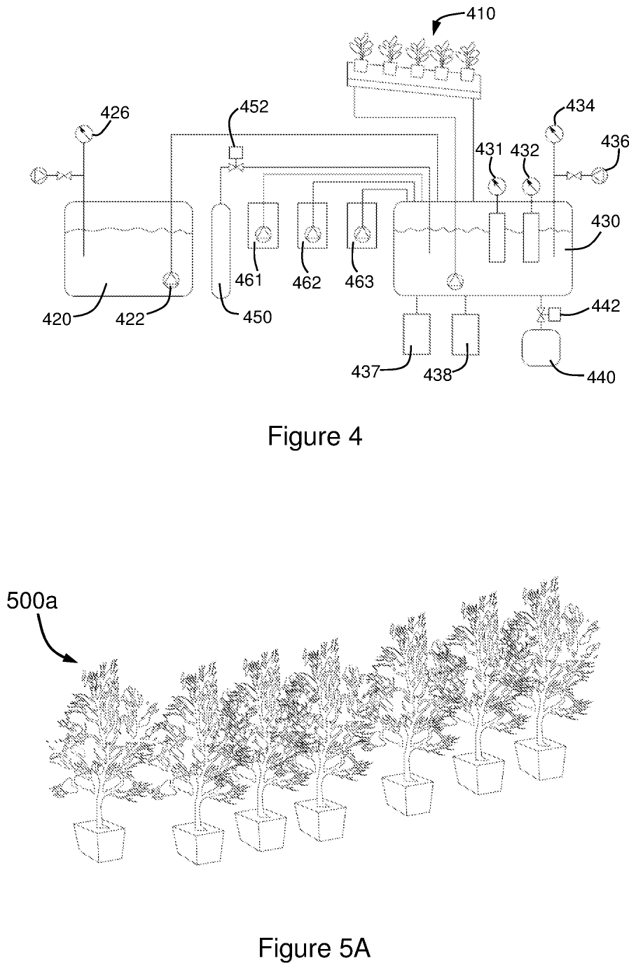

FIG. 4 illustrates an operation inside a hydroponics farming apparatus according to an example embodiment of the present invention.

As illustrated, nutrients solution is provided from a nitrified and pH controlled water reservoir 430 to plants 410. The water reservoir 430 has fluid communication with a clean water reservoir 420, a CO₂ tank 450, three nutrients supply tanks 461, 462, and 463, and a waste water reservoir 440. By way of example, the supply tank 461 contains potassium nitrate (KNO₃), calcium nitrate (Ca(NO₃)₂), and ferric ethylenediaminetetraacetic acid (FeEDTA). The supply tank 462 contains magnesium sulfate (MgSO₄), monopotassium phosphate (KH₂PO₄), zinc sulfate (ZnSO₄), manganese sulfate (MnSO₄), copper(II) sulfate (CuSO₄), boric acid (H₃BO₃) and sodium molybdate (Na₂MoO₄). The supply tank 463 contains KNO₃, Ca(NO₃)₂, and FeEDTA.

The volume of water in the clean water reservoir 420 is monitored by a water level sensor 426 to ensure there is enough clean water available. If the water level is below a threshold, water will be refilled into the clean water reservoir 420 from a water source. Water in the clean water reservoir 420 can be pumped into the water reservoir 430 via a water pump 422.

A CO₂ sensor collect CO₂ level inside the farm and the CO₂ tank 450 can be controlled with a solenoid valve 452 to release a desirable amount of CO₂ to maintain the CO₂ level. The nutrients solution reservoir volume sensor 434 collects data as to how much nutrients solution is remaining in the water reservoir 430. An electrical conductivity (EC) sensor 431 and a pH sensor 432 monitor the EC level and pH levels so as to control solenoid valves of nutrients supply tanks 461, 462, and 463, as well as an air pump 436. When needed, desirable amount of nutrients supply and oxygen can be added into the reservoir 430. A pH up tank 437 and a pH down tank 438 are provided and in fluid communication with the reservoir 430 for adjusting pH level of nutrient solution in the reservoir 430. For example, when the pH level is lower than a threshold value, a proper amount of solution from the pH up tank 437 can be inputted into the reservoir 430 to increase the pH level. When the pH level is higher than a threshold value, a proper amount of solution from the pH down tank 438 will be inputted into the reservoir 430 to decrease the pH level. Once the used nutrients solution is no longer optimal to reuse, it can be transferred to the waste water reservoir 440 with a drain solenoid valve 442. In some embodiments, an oxidation reduction potential (ORP) sensor and a tilt angle sensor are provided. The ORP sensor measures the ORP level of the nutrient solutions in the reservoir 430. The tilt angle sensor can be arranged in a proper location (such as within one of the modular storage cabinets) in the farm and measures tilt angle of the hydroponics farming apparatus.

Controlling over equipment, means, such as valves, pumps, can be done by a main controller. Alternatively, data collected by multiple sensors are provided to the main controller, and then sent to an AI system (such as AI-enabled cloud server, AI-enabled portable electronic device, etc.) for further process. Instructions are generated based on the processed results and sent back to the main controller for controlling relative equipment, means, etc.

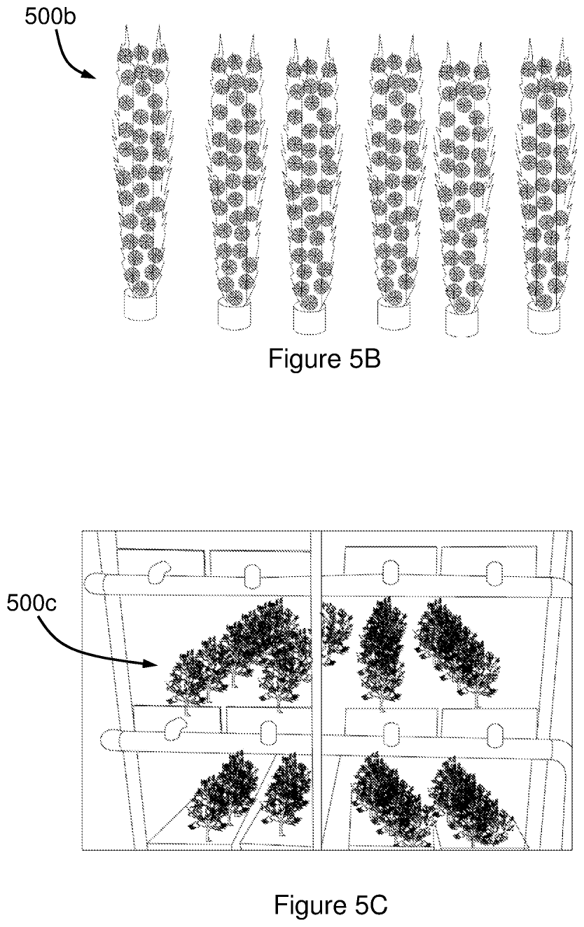

FIGS. 5A-5C illustrates plants to be used in a bucket system, a tower system, and a stack tray system respectively.

According to one or more embodiment, the farm is suitable for various farming methods and different types of plants. For example, in the farm there may be 48 planting spots with the layout of four columns by fourteen rolls distributed inside the farm. Each plant is given an identification number used for formulated data collection. An AI system may identify specific farm and specific plant via identification number. The AI system may collect data and remotely control the farming process in multiple farms.

FIG. 5A illustrates bushy plants or vertical plants 500a that are suitable for the bucket system. By way of example, a nutrients solution supply pipe is connected with 48 drip nozzles where nutrients solution is supplied directly to the roots of plant in each bucket. Each bucket is provided with one plant opening. As a result, each farm allows farming of 48 plants. On the top of the bucket there is a lid with one single opening for fitting a net pot. The net pot is provided with a growing medium which the plant roots use as a foundation. The bucket collects the remaining nutrients solution where it is drained into a nutrients solution return pipe mounted under the floor that connects to a pump. Alternatively, the remaining nutrients solution is directly collected on a sloped bottom floor and flows towards a desirable site for collection. The remaining nutrients solution may be transferred into a nutrients solution reservoir. Each bucket may be assigned with a specific identification number for data collection.

FIG. 5B illustrates leafy plants 500b that are suitable for the tower system. By way of example, a nutrients solution supply pipe is connected with 48 drip nozzles where nutrients solution flows downwards inside the tower reaching the roots of the plants. Each tower includes 28 plant openings with a total of 1,344 plant opening per farm. Each opening is provided with a net pot together with growing medium which the plant roots use as a foundation. On the top of the bucket there is a lid with one opening allowing the tower to fit into the bucket. The bucket is used to collect the remaining nutrients solution where it is drained into a nutrients solution return pipe mounted under the floor that connects to a pump. The remaining nutrients solution may be transferred into a nutrients solution reservoir. Each tower plant opening is assigned with a specific identification number for data collection.

FIG. 5C illustrates microgreens/sprouts/shoots plants 500c that are suitable for the stack tray system. For purpose of illustration more clearly, part of the stack tray system is also illustrated. By way of example, a nutrients solution supply pipe is connected with 48 drip nozzles where nutrients solutions flows downwards filling the tray with nutrients solution reaching the roots of the plants. Each stack tray includes five levels of trays and covers an area of four buckets with a total of fourteen stack trays per farm. The trays can be used with the fodder method or can be individualized with a net pot. Four drip nozzles supply nutrients solutions to the top tray and continue to flow downwards to the tray below until reaching to the lowest tray. The remaining nutrients solution drains into a nutrients solution return pipe mounted under the floor that connects to a pump. The remaining nutrients solution may be transferred back into a nutrients solution reservoir. Each stack tray is assigned with a specific identification number for data collection.

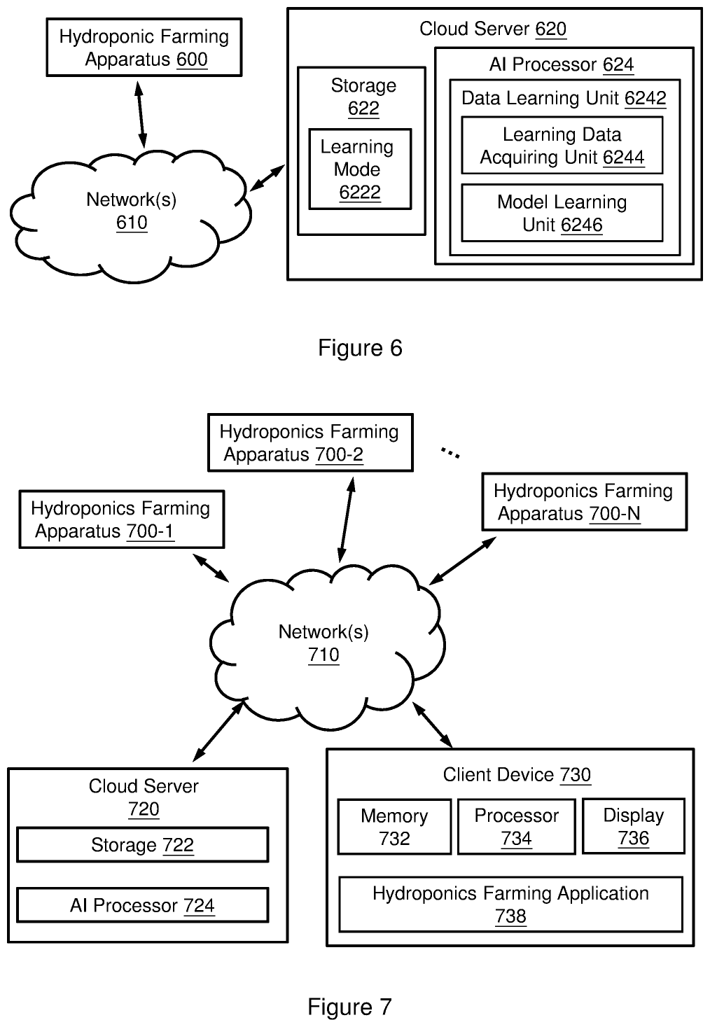

FIG. 6 illustrates a hydroponics farming system according to an example embodiment of the present invention.

As illustrated, the hydroponics farming system includes a hydroponics farming apparatus 600 and a cloud server 620 that communicates with the hydroponics farming apparatus 600 via one or more networks 610. The cloud server 620 includes a storage or memory 622 and an AI processing unit or AI processor 624.

The hydroponics farming apparatus 600 establishes a farm for farming of one or more plants and collect various parameters or data associated with conditions of the farming via a plurality of sensors. The data are provided to the cloud server 620 via the networks 610. The data may be stored in the storage 622 and processed by the AI processor 624 to obtain formulated data.

The cloud server 620 performs AI processing. The AI processing may include operations related to farming of the plants in the farm. For example, the cloud server 620 may perform various operations of processing and control signal generating by performing AI processing on sensed data received from the hydroponics farming apparatus 600 related to growing conditions or controlling of the plants. Further, for example, the cloud server 620 may perform autonomous control by performing AI processing on data acquired through interaction with electronics (such as a main controller) included in the hydroponics farming apparatus 600.

By way of example, the cloud server 620 is a computing device that can learn a neural network. The AI processor 624 can learn a neural network using programs stored in the storage 622. The AI processor 624 may learn a neural network for recognizing data related to hydroponics farming. The neural network for recognizing data related to hydroponics farming may be designed to simulate the brain structure of human on a computing device and may include a plurality of network nodes having weights and simulating the neurons of human neural network. The plurality of network nodes can transmit and receive data in accordance with each connection relationship to simulate the synaptic activity of neurons in which neurons transmit and receive signals through synapses. The neural network may include a learning mode, such as a deep learning model, developed from a neural network model. In the deep learning model, for example, a plurality of network nodes is positioned in different layers and can transmit and receive data in accordance with a convolution connection relationship. The neural network, for example, includes various deep learning techniques such as deep neural networks (DNN), convolutional deep neural networks (CNN), recurrent neural networks (RNN), a restricted Boltzmann machine (RBM), deep belief networks (DBN), and a deep Q-network, and can be applied to fields such as computer vision, voice recognition, natural language processing, and voice/signal processing.

The storage 622 may store various programs and data for the operation of the cloud server 620. The storage 622 is accessed by the AI processor 624 and reading out/recording/correcting/deleting/updating, etc. of data by the AI processor 624 can be performed. Further, the storage 622 can store a neural network model (e.g., a learning model 6222) generated through a learning algorithm for data classification/recognition according to one or more embodiments of the present invention.

The AI processor 624 may include a data learning unit 6242 that is implemented as a hardware module, a software module, or combination thereof. The data learning unit 6242 learns a neural network for data classification/recognition. The data learning unit 6242 may learn references about what learning data are used and how to classify and recognize data using the learning data in order to determine data classification/recognition. The data learning unit 6242 may learn a deep learning model by acquiring learning data to be used for learning and by applying the acquired learning data to the deep learning model.

The data learning unit 6242 may include a learning data acquiring unit 6244 and a model learning unit 6246. The learning data acquiring unit 6244 can acquire learning data required for a neural network model for classifying and recognizing data. For example, the learning data acquiring unit 6244 can acquire, as learning data, plant farming data and/or sample data to be input to a neural network model. The model learning unit 6246 can perform learning such that a neural network model has a determination reference about how to classify predetermined data, using the acquired learning data. The model learning unit 6246 may train a neural network model through supervised learning, unsupervised learning, reinforcement learning, or using a learning algorithm including error back-propagation or gradient decent. When a neural network model is learned, the model learning unit 6246 can store the learned neural network model in the storage 622.

The cloud server 620 has capacity of cloud computing. In some embodiments, the cloud server 620 performs operations on big data. This is favorable as there are generally a huge amount of data related to plant farming that is difficult to handle by a computer with ordinary computing ability.

FIG. 7 illustrates a hydroponics farming system according to another example embodiment of the present invention.

As illustrated, the hydroponics farming system includes hydroponics farming apparatus 700-1, 700-2 . . . and 700-N, where N is a natural number. A cloud server 720 communicates with each of these hydroponics farming apparatus via one or more networks 710. The cloud server 720 includes a storage or memory 722, an AI processing unit or AI processor 724.

Each of the hydroponics farming apparatus 700-1, 700-2 . . . and 700-N may be a specific implementation of the hydroponics farming apparatus 100, 300, or 600, and the cloud server 720 may be a specific implementation of the cloud server 620. The cloud server 720 communicates with each individual hydroponics farming apparatus, receives data, and processes the data based on AI algorithms.

As the number of the hydroponics farming apparatus increases, the amount of data to be processed will increase significantly. This will impose great challenges. The cloud server 710, by adopting big data and clouding computing technology, can have capacity to deal with a huge amount of data related to farming in multiple locations.

In some embodiment, the cloud server 720 can use one or more specific hydroponics farming apparatus for data training to develop machine learning algorithms. In some embodiment, the cloud server 720 has well-developed learning modes and generate formulated data for plant farming. As a result, the formulated data can be used to increase consistent quality control, thereby giving users (such as farmers) the ability to control multiple farms located in different locations with lesser investment in manpower and equipment.

As illustrated, in some embodiments, the hydroponics farming system includes a client device 730. The client device 730 may be, but not limited to, a tablet, a laptop, a smartphone, an iPad, or the like.

As illustrated, the client device 730 includes a memory 732, a processor 734, a display 736 and a hydroponics farming application 738. The client device 730 may receive data from one or more of the hydroponics farming apparatus 700-1, 700-2 . . . and 700-N, store the received data in the memory 732, process the received data with the processor 734 and the hydroponics farming application 738, and display the results on the display 736 for review.

In some embodiments, the client device 730 may retrieve data or the processed results from the cloud server 720 and display the retrieved results on the display 736 for review. In some embodiments, the client device 730 may retrieve data or the processed results from the cloud server 720 and conducts further processing of the received data.

In some embodiments, the client device 730 includes a user interface, such as keyboards, touchscreen, etc. that receives user's input. In some embodiments, the client device 730 may generates instructions one its own or responding to user's input, and send the generated instructions to one or more of the hydroponics farming apparatus 700-1, 700-2 . . . and 700-N for controlling the farming conditions.

In some embodiments, the client device 730 is an artificial intelligence-enabled device that implements a local artificial intelligence leaning mode. The client device retrieves data from the cloud server and implements training of the local artificial intelligence leaning mode based on the data retrieved.

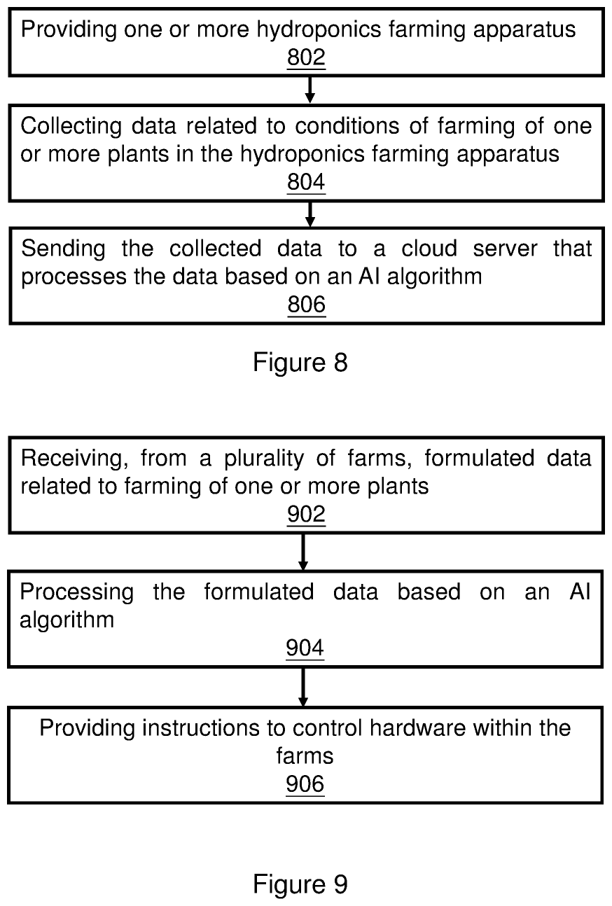

FIG. 8 is a flowchart illustrating a hydroponics farming method according to an example embodiment of the present invention. The method, for example, can be executed by a system, such as the hydroponics farming system as described with reference to FIG. 7, for improved plant production.

At block 802, one or more hydroponics farming apparatus are provided. The hydroponics farming apparatus, for example, may be a hydroponics farming apparatus as stated above with reference to one or more figures. The hydroponics farming apparatus is used to establish a farm for production of one or more plants. The hydroponics farming apparatus is portable and can be relocated to a proper location.

At block 804, data related to conditions of farming of the one or more plants in the hydroponics farming apparatus are collected. This may be done with multiple sensors, such as temperature sensors, humidity sensors, light sensors, etc.

At block 806, the collected data are sent to a cloud server that processes the data based on AI algorithms. The cloud server is an AI-enabled cloud server equipped with capacity of big data and cloud computing. The cloud server generates formulated data and based on developed learning modes, can instruct a plurality of hydroponics farms to achieve consistent, quality control, and in the meanwhile reduce human intervention.

FIG. 9 is a flowchart illustrating a hydroponics farming method according to another example embodiment of the present invention. The method, for example, can be executed by a cloud server, such as cloud server 620, 720 as described above.

Block 902 states receiving, from a plurality of farms, formulated data related to farming of one or more plants. Each of the plurality of farms is established by a respective hydroponics farming apparatus. Each of the hydroponics farming apparatus has same equipment (hardware and software). Therefore, the collected data that are intrinsic to hydroponics farming apparatus can be same. The variations results mainly from environmental conditions specific to physical locations, such as temperature, humidity, solar intensity, etc. In this way, the data received are formulated data that are not affected by the hydroponics farming apparatus per se. This formulated data collection method increases consistent quality control, thereby giving users the ability to control multiple farms located in different locations with lesser investment in manpower and equipment.

Block 904 states processing the formulated data based on an AI algorithm. The data may be processed by an AI processor with the AI algorithm. The AI algorithm enables intelligent interaction with farms for farming in multiple locations.

Block 906 states providing instructions to control hardware within the farms. Based on the processed results, the AI system generates instructions to control hardware in the farms. For example, if CO₂ level in a farm is determined lower than a threshold value, the AI system will generate instructions such that a solenoid valve is automatically opened to enable releasing CO₂ of from a CO₂ supply tank, thereby increasing the CO₂ level in the farm.

As used herein, the term “farm” or “farming area” refer to an area for farming one or more plants that is mainly established by a hydroponics farming apparatus. For example, the interior space defined by the frame of a hydroponics farming apparatus may constitute a major portion of the farm. However, the farm should not be understood as limited to the interior space.

As used herein, the term “formulated data” refer to data collected from each of a plurality of farms where each farm is established by a respective hydroponics farming apparatus, and all the hydroponics farming apparatus have same equipment (i.e. hardware and software). That is, data intrinsic to hydroponics farming apparatus per se can be same. The variations result substantially from environmental conditions specific to physical locations of the farms.

Unless otherwise defined, the technical and scientific terms used herein have the plain meanings as commonly understood by those skill in the art to which the example embodiments pertain. Embodiments are illustrated in non-limiting examples. Based on the above disclosed embodiments, various modifications that can be conceived of by those skilled in the art fall within scope of the example embodiments.

What is claimed is:

1. A hydroponics farming apparatus for plant production, comprising:
a frame configured to define an interior space for farming one or more plants;
a plurality of functional systems configured to facilitate farming of the one or more plants;
a first plurality of sensors configured to monitor conditions associated with farming of the one or more plants;
one or more modular storage cabinets removably attached to the frame and including electronics that are pre-assembled in the one or more modular storage cabinets and configured to communicate with one or more of the first plurality of sensors and the plurality of functional systems, the one or more modular storage cabinets including interfaces that are pre-constructed and configured to interface with one or more of the plurality of functional systems, the electronics including a main controller configured to collect data from the first plurality of sensors and provide instructions related to controlling of the plurality of functional systems.

2. The hydroponics farming apparatus of claim 1, wherein the main controller is further configured to communicate with an external electronic system, and wherein the main controller communicates the collected data to the external electronic system for processing, and provides instructions related to controlling of the plurality of functional systems based on the processed results by the external electronic system.

3. The hydroponics farming apparatus of claim 1, wherein the one or more modular storage cabinets includes a second plurality of sensors configured to detect further conditions associated with farming of the one or more plants.

4. The hydroponics farming apparatus of claim 1, wherein the one or more modular storage cabinets include a climate system configured to control environmental conditions of the interior space, and an irrigation system configured to provide fluid nutrients to the one or more plants.

5. The hydroponics farming apparatus of claim 4, wherein the climate system includes ventilation means configured to adjust temperature and humidity of the interior space, and sensing means configured to collect temperature and humidity data and provide the temperature and humidity data to the main controller.

6. The hydroponics farming apparatus of claim 4, wherein the irrigation system includes a reverse osmosis filtration system for filtering water received from a water supply, a reverse osmosis reservoir for storing the water received from the reverse osmosis filtration system, and a clean water reservoir for storing the water received from the reverse osmosis reservoir.

7. The hydroponics farming apparatus of claim 6, wherein the irrigation system includes a volume sensor and a temperature sensor disposed in the clean water reservoir, the temperature sensor configured to monitor temperature of water in the clean water reservoir, the volume sensor configured to monitor volume of water in the clean water reservoir.

8. The hydroponics farming apparatus of claim 6, wherein the irrigation system includes at least one of a rainwater collection reservoir configured to collect rainwater through one or more rain collection pipes attached to the frame of the hydroponics farming apparatus and a seawater desalination reverse osmosis system that transforms seawater into water for plant irrigation.

9. The hydroponics farming apparatus of claim 4, wherein the irrigation system includes a nutrients supply tank for supplying nutrients, a nutrients solution reservoir connected to nutrients supply tank and for preparing nutrients solution, a plurality of sensing means for monitoring parameters associated with nutrients solution, a temperature adjusting means for changing temperature of the nutrients solution, a stirring means for stirring the nutrients solution, and one or more pH adjustment tanks in fluid communication with the nutrients solution reservoir for adjusting pH level of nutrients solution in the nutrients solution reservoir.

10. The hydroponics farming apparatus of claim 9, further comprises a nutrients solution conveying means configured to convey nutrients solution from the nutrients solution reservoir to the one or more plants, and a nutrients solution returning means configured to return unused nutrients solution to the nutrients solution reservoir.

11. The hydroponics farming apparatus of claim 1, wherein the plurality of functional systems include a plurality of lighting devices, and the first plurality of sensors include light sensors for collecting lighting information associated with the plurality of lighting devices, at least a first one or more of the lighting devices being attached to an interior wall of the hydroponics farming apparatus, at least a second one or more of the lighting devices being attached to a ceiling of the hydroponics farming apparatus.

12. The hydroponics farming apparatus of claim 1, wherein the plurality of functional systems include one or more energy harvesting devices, the energy harvesting devices including at least one of photovoltaic devices, wind turbines, and hydrogen fuel cells, and
when the energy harvesting devices includes a photovoltaic device, the electronics of the one or more modular storage cabinets includes balance-of-system and sensing means for facilitating management of solar energy harvested from the photovoltaic device.

13. The hydroponics farming apparatus of claim 1, wherein the plurality of functional systems includes one or more video-capturing devices for collecting visual information and communicating the visual information to the main controller.

14. The hydroponics farming apparatus of claim 1, further comprising one or more of a bucket system, a tower system, and a stack tray system for farming of the one or more plants.

15. The hydroponics farming apparatus of claim 1, wherein the plurality of functional systems includes a pollination device that helps collect pollen from a male plant and transfer pollen to fertilize female plants.

16. A hydroponics farming system for plant production, comprising:
at least one hydroponics farming apparatus for farming one or more plants, each of the at least one hydroponics farming apparatus including one or more modular storage cabinets removably mounted within the hydroponics farming apparatus;
one or more networks; and
a cloud server communicating with the at least one hydroponics farming apparatus via the one or more networks, the cloud server including a storage for storing data received from the at least one hydroponics farming apparatus and an artificial intelligence processor for processing the data based on an artificial intelligence algorithm to obtain processed results, the cloud server being configured to generate instructions based on the processed results and provide the instructions to the at least one hydroponics farming apparatus for controlling farming of the one or more plants.

17. The hydroponics farming system of claim 16, wherein the storage stores a learning mode generated through a learning algorithm, and wherein the artificial intelligence processor includes a learning data obtaining unit that learns a neural network for data classification and recognition related to farming of the one or more plants in the at least one hydroponics farming apparatus.

18. The hydroponics farming system of claim 16, further comprising a client device that communicates with the cloud server via the one or more networks, wherein the client device includes a hydroponics farming application that enables remote control over the at least one hydroponics farming apparatus.

19. The hydroponics farming system of claim 16, wherein the at least one hydroponics farming apparatus includes two or more hydroponics farming apparatus, each hydroponics farming apparatus being associated with a unique identification, wherein the cloud server identifies each hydroponics farming apparatus by its unique identification.

20. The hydroponics farming system of claim 19, wherein each of the two or more hydroponics farming apparatus includes same hardware and software, and wherein the cloud server receives formulated data that facilitates farming in the two or more hydroponics farming apparatus.
